(19) United States
(12) Patent Application Publication
(10) Pub. No.: US 2026/0148955 A1
(43) Pub. Date: May 28, 2026

(54) ELECTRODE PLATE MANUFACTURING METHOD AND APPARATUS

(71) Applicant: SAMSUNG SDI CO., LTD., Yongin-si (KR)

(72) Inventors: Daehui YUN, Yongin-si (KR); Hyo-jung SONG, Yongin-si (KR); Heeae SO, Yongin-si (KR); Seungman LIM, Yongin-si (KR)

(21) Appl. No.: 19/270,795

(22) Filed: Jul. 16, 2025

(30) Foreign Application Priority Data
Nov. 22, 2024 (KR) 10-2024-0168850

(51) Int. Cl. H01M 4/04

(52) U.S. Cl. CPC H01M 4/0404

(57) ABSTRACT

A manufacturing method for an electrode plate includes performing a first drying of a slurry coated on a substrate, machining a groove in the slurry while the slurry is being dried, and performing a second drying of the slurry, such that the slurry is continuously dried during the first drying and the second drying until the slurry with the groove is dry to create an active material layer on the substrate.

### CROSS-REFERENCE TO RELATED APPLICATION

This application claims priority to and the benefit of Korean Patent Application No. 10-2024-0168850 filed with the Korean Intellectual Property Office on Nov. 22, 2024, the entire contents of which are incorporated herein by reference.

### BACKGROUND

### 1. Field

The present disclosure relates to a method and an apparatus for manufacturing an electrode plate.

### 2. Description of the Related Art

Rechargeable batteries may be used not only in small devices such as portable electronic devices, but also in medium and large devices such as battery packs for hybrid or electric vehicles or power storage devices. Such rechargeable batteries may be chargeable and dischargeable power sources including a stack structure of positive electrode/separator/negative electrode, where a positive electrode includes a lithium metal oxide as a positive electrode active material, and a negative electrode includes a carbon negative electrode active material such as graphite, with lithium ions moving between the positive and negative electrodes during charging and discharging, thereby repeating a charge and discharge cycle.

In this case, the graphite material such as natural graphite may be used as the negative electrode active material. This graphite may have a layered structure, and may be made up of many layers of carbon atoms spread out in a plane forming a network structure.

During charging, lithium ions penetrate an edge surface (surface where layers overlap) of the graphite layer and diffuse between the layers. In addition, during discharging, lithium ions may be extracted and released from the edge surface of the layer.

Additionally, graphite has a lower electrical resistivity in a plane direction of the layers than that in the stacking direction of the layers, so a conduction path for electrons that detour along the plane direction of the layers may be created.

### SUMMARY

An embodiment of the present disclosure provides a manufacturing method for an electrode plate, the method including a first drying operation for drying a slurry coated on a substrate, a groove machining operation for creating a groove in the slurry during a drying process of the slurry, and a second drying operation for continuously drying the slurry until the drying of the slurry in which the groove is created is completed, to create an active material layer.

The first drying operation may dry the slurry by 70% or more.

The groove machining operation may be performed when the slurry is 70% to 80% dried.

The first drying operation and the second drying operation may be performed sequentially.

A negative electrode solid concentration of the slurry may be in a range of 50 to 60 wt %.

A positive electrode solid concentration of the slurry may be in a range of 70 to 80 wt %.

The active material layer may include a positive electrode active material.

The positive electrode active material may be one of a lithium manganese oxide, a lithium nickel oxide, a lithium cobalt oxide, a lithium nickel manganese oxide, a lithium nickel cobalt manganese oxide, a lithium nickel cobalt aluminum oxide, a lithium phosphoric acid iron compound, a lithium phosphoric acid manganese compound, a lithium phosphoric acid cobalt compound, and a lithium phosphoric acid vanadium compound.

The active material layer may include a negative electrode active material.

The negative electrode active material may be a material into which lithium ions can be inserted and delithiated. For example, the negative electrode active material may be any one of a carbon material such as crystalline carbon, amorphous carbon, carbon composites, or carbon fibers, a lithium alloy, silicon (Si), or tin (Sn).

An embodiment of the present disclosure provides an electrode plate manufacturing apparatus including a heating unit configured to dry a slurry coated on a substrate, and a groove machining unit installed inside the heating unit and configured to create a groove in the slurry while drying of the slurry is not complete.

The heating unit may include a hot air injection member installed spaced apart from the substrate and configured to spray hot air toward the slurry, and a heating member positioned on an opposite side to the hot air injection member based on the substrate and configured to heat the substrate by generating heat.

The groove machining unit may include a grooved member configured to include a body portion and a plurality of protrusions positioned on a circumferential surface of the body portion, and a driving member coupled with the groove machining member and configured to rotate the groove machining member.

The protrusion may have a conical shape.

### BRIEF DESCRIPTION OF THE DRAWINGS

Features will become apparent to those of skill in the art by describing in detail exemplary embodiments with reference to the attached drawings, in which:

FIG. 1 illustrates an exploded perspective view of a rechargeable battery manufactured according to a manufacturing method according to an embodiment of the present disclosure;

FIG. 2 illustrates a cross-sectional view of an electrode plate included in the rechargeable battery of FIG. 1;

FIG. 3 illustrates a flowchart of a manufacturing method for an electrode plate according to an embodiment of the present disclosure;

FIG. 4 illustrates a photograph taken with an electron microscope at a magnification of 500 times of an active material layer in which a groove was created;

FIG. 5 illustrates a photograph taken with an electron microscope at a magnification of 1000 times of an active material layer in which a groove was created;

FIG. 6 illustrates a cross-sectional view showing an electrode plate manufacturing apparatus according to an embodiment of the present disclosure;

FIG. 7 illustrates a perspective view showing an extract of a groove machining unit included in the electrode plate manufacturing device of FIG. 6; and

FIG. 8 illustrates a cross-sectional view schematically showing a state in which an active material layer in which a groove is formed is in contact with an electrolyte.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the term “and/or” includes any and all combinations of one or more of the listed items. Furthermore, the meaning of “connected” in this specification indicates not only when a member A and a member B are directly connected, but also when a member C is interposed between the member A and the member B, and the member A and member B are indirectly connected.

The terminology used herein is for the purpose of describing certain embodiments only and is not intended to limit the present disclosure. As used in this specification, the singular form may include a plurality of forms, unless the context clearly indicates otherwise. Additionally, when used herein, “comprise,” “include,” “comprising,” and/or “including” specify the presence of the mentioned figures, numbers, steps, actions, members, elements and/or groups of these, and does not exclude the presence or addition of one or more other shapes, numbers, operations, members, elements and/or groups.

Although the terms first, second, etc. are used in this specification to describe various elements, components, regions, layers and/or portions, it is to be obvious that these elements, components, regions, layers and/or portions should not be limited by these terms. These terms are used only to distinguish one member, component, region, layer, or portion from another region, layer, or portion. Accordingly, the first member, component, region, layer, or portion described below may refer to the second member, component, region, layer, or portion without departing from the teachings of the present disclosure.

Furthermore, spatial terms such as “beneath,” “below,” “lower,” “above,” and “upper” may be used to facilitate understanding of one element or feature depicted in a drawing relative to another element or feature. These terms related to space are provided for easy understanding of the present disclosure according to various process states or usage states of the present disclosure, and are not intended to limit the present disclosure. For example, if an element or feature in a drawing is flipped, the element or feature described as “beneath” or “below” becomes “above” or “upper.” Accordingly, “beneath” is a concept that includes “above” or “below.”

Before describing a method for manufacturing an electrode plate according to one embodiment of the present disclosure, a rechargeable battery to which an electrode plate manufactured by the method for manufacturing an electrode plate may be applied will be described.

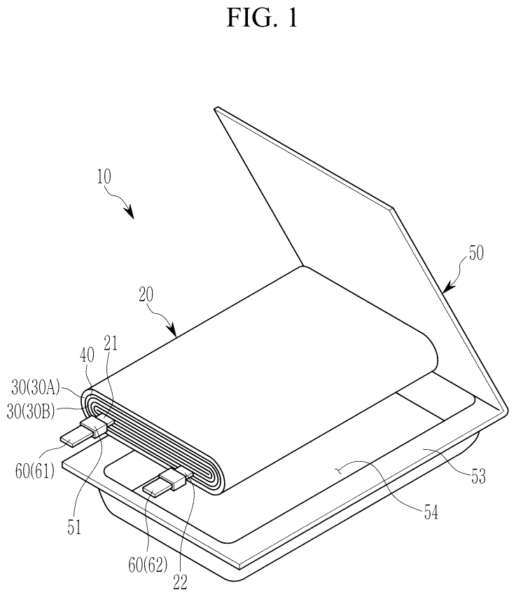

FIG. 1 illustrates an exploded perspective view of a rechargeable battery manufactured according to a manufacturing method according to an embodiment of the present disclosure.

Referring to FIG. 1, a rechargeable battery 10 may include an electrode assembly 20, an electrode lead 60, and a case 50. The electrode assembly 20 may include a plurality of electrode plates 30 and a separator 40. For example, the electrode plates 30 may include a first electrode plate 30A and a second electrode plate 30B.

This electrode assembly 20 may be in a form of a stack including the first electrode plate 30A, the second electrode plate 30B, and the separator 40 that is wound or repeatedly stacked. For example, the electrode assembly 20 may be a stack type in which the first and second electrode plates 30A and 30B are arranged to be stacked in multiple layers. In another example, the electrode assembly 20 may be of a repeatedly wound jelly-roll type, where there may be one first electrode plate 30A and one second electrode plate 30B (e.g., such a jelly roll type electrode assembly 20 may be manufactured in a manner in which a stack in which the first electrode plate 30A, the separator 40, and the second electrode plate 30B are stacked and wound on two winding beams).

The separator 40 may be provided between the first electrode plate 30A and the second electrode plate 30B. The separator 40 prevents short-circuiting between the first electrode plate 30A and the second electrode plate 30B, and may enable movement of lithium ions. For example, the separator 40 may be formed to have a relatively larger size than the first electrode plate 30A or the second electrode plate 30B.

The separator 40 may include, e.g., a porous polymer film or a porous non-woven fabric. Herein, the porous polymer film may be formed of a single layer or multiple layers including a polyolefin polymer such as an ethylene polymer, a propylene polymer, an ethylene/butene copolymer, an ethylene/hexene copolymer, and an ethylene/methacrylate copolymer. The porous non-woven fabric may include a high-melting point glass fiber and a polyethylene terephthalate fiber. However, the present disclosure is not limited thereto, and according to an embodiment, the separator may be a ceramic coated separator (CCS) including ceramic.

For example, the separator 40 may be installed to be wound in a direction between the first electrode plate 30A and the second electrode plate 30B. In another example, when the electrode plates 30A and 30B are in a stacked form, the separator 230 may be cut into unit lengths and positioned between the first electrode plate 30A and the second electrode plate 30B, or a single separator formed in a ribbon shape may be positioned in a zigzag shape between the first electrode plate 30A and the second electrode plate 30B.

As further illustrated in FIG. 1, the aforementioned electrode assembly 20 may include electrode tabs 21 and 22. The electrode tabs 21 and 22 may extend from the first electrode plate 30A and the second electrode plate 30B, respectively. An electrode tab extending from the first electrode plate 30A may be the first electrode tab 21, and an electrode tab extending from the second electrode plate 30B may be the second electrode tab 22.

The electrode lead 60 may be connected to the electrode tabs 21 and 22. The electrode lead 60 may include two electrode leads 61 and 62. A first electrode lead 61 may be connected to the first electrode tab 21, and a second electrode lead 62 may be connected to the second electrode tab 22, or vice versa. That is, the first electrode plate 30A and the second electrode plate 30B may be electrically connected to an outside of the rechargeable battery 10 through the electrode lead 60.

A protective member 51 may be installed to wrap a portion of the electrode lead 60 corresponding to the case 50. The protective member 51 may prevent the electrode lead 60 and the case 50 from being electrically connected.

The case 50 may accommodate the electrode assembly 20. The electrode assembly 20 may be accommodated in the case 50 together with an electrolyte.

Herein, the electrolyte may be a non-aqueous electrolyte. The electrolyte may include a lithium salt and an organic solvent. The organic solvent may include at least one of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, or tetrahydrofuran.

The case 50 as described above may be any one of a pouch type, a cylindrical type, and a square type. A pouch-like case 50 may be manufactured by bending plate-shaped outer materials such that they face each other, then pressing or drawing one surface and including a recess on one surface.

The electrode assembly 20 may be accommodated in a recess 54 of the case 50. A sealing portion 53 may be provided on an outer periphery of the recess 54, and the sealing portion 53 may be sealed by a method such as heat fusion while the electrode assembly 20 is accommodated in the recess 54.

The electrode plates 30A and 30B may include the first electrode plate 30A and the second electrode plate 30B. The first electrode plate 30A may be used as a negative electrode plate, and the second electrode plate 30B may be used as a positive electrode plate, or vice versa.

The first and second electrode tabs 21 and 22 may be a positive electrode tab and a negative electrode tab, respectively. The first electrode tab 21 may extend from the first electrode plate 30A (i.e., from the negative electrode plate), and the second electrode tab 22 may extend from the second electrode plate 30B (i.e., from the positive electrode plate).

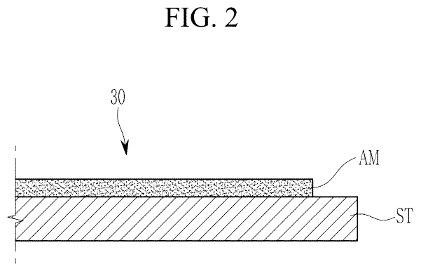

Hereinafter, the electrode plate 30 in the rechargeable battery 10 will be described in detail with reference to FIG. 2. FIG. 2 illustrates a cross-sectional view showing the electrode plate 30 included in the rechargeable battery of FIG. 1.

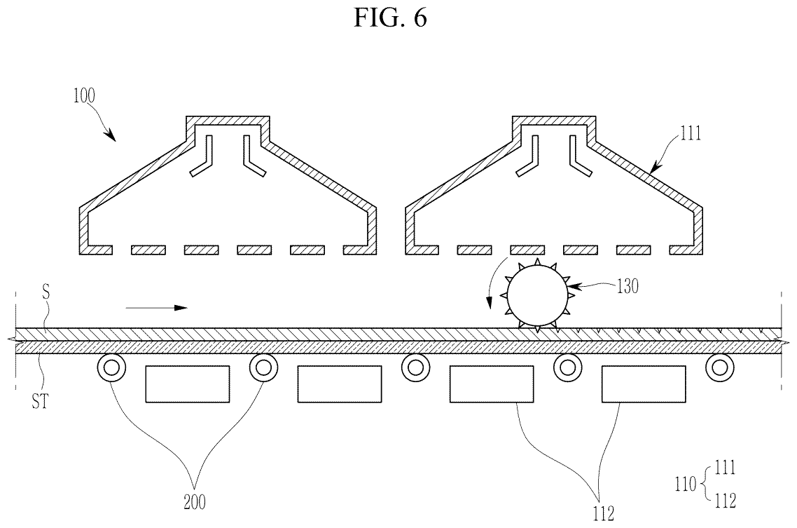

Referring to FIGS. 1-2, in the manufacturing process of the electrode plate 30 included in the electrode assembly 20, an active material layer AM may be created by coating a slurry S (FIG. 6) on a substrate ST.

The substrate ST may be a current collector, and the current collector may include any suitable conductive material that does not cause a chemical reaction within a rechargeable battery. For example, the current collector may include any of stainless steel, nickel (Ni), aluminum (Al), titanium (Ti), copper (Cu), or an alloy thereof, and may be provided in various forms such as a film, a sheet, or a foil. The substrate ST may include a current collector and a non-conductor portion.

The active material layer AM may be applied to at least one surface of the substrate ST. The active material layer AM may be applied to a remaining region except an edge region of the current collector (e.g., an edge of the substrate ST). In this case, the edge region of the current collector may be an uncoated region where the active material layer AM is not applied.

The active material layer AM may be positioned on at least a portion of a first surface of the substrate ST, and may have multi-layered end portions. As illustrated in FIG. 2, an edge of the above active material layer AM may be positioned spaced apart from an edge of the substrate ST. In addition, a protective film may be attached to a boundary portion between the active material layer AM and the substrate ST.

For example, a method for forming the active material layer AM on the substrate ST may include using a slit coater to discharge slurry onto a current collecting layer, and then sequentially performing a magnetization process using a permanent magnet and a drying process using a heater. In another example, a method for forming the active material layer AM on the substrate ST may include attaching a film-shaped active material layer to the current collecting layer. In this case, the active material layer may be, e.g., a dry active material film. A method for manufacturing a dry active material film may include mixing a binder and an active material, heating (melting) and stirring in a twin-screw stirrer, and then extruding the same through a nozzle.

In the present disclosure, a description will be limited to a case where a slurry is coated on the substrate ST by a slit coater to form the active material layer AM. A magnetizing device may magnetize the slurry discharged by the slit coater. The magnetizing device may apply a magnetic field to the slurry applied on the substrate ST to orient it.

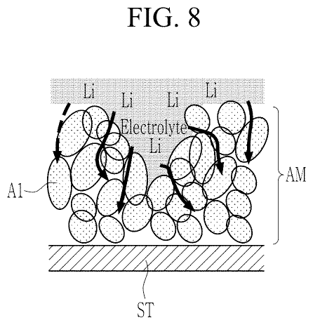

Referring to FIGS. 2 and 8, the active material layer AM may include, e.g., a graphite particle A1, a binder, and a conductive material. The graphite particle A1 may have diamagnetic anisotropy. For example, the graphite particle A1 may have a plate-like shape. An average particle diameter of the graphite particle A1 may be 0.05 μm to 30 μm. The graphite particle A1 may include a bulk particle and a fine particle. For example, the bulk particle may have an average particle diameter of 1 μm to 30 μm, and the fine particle may have an average particle diameter of 0.05 μm or more and less than 1 μm.

When a content of the fine particle is high, a reactivity with lithium ions may increase due to an increase in surface area. However, when the content of the fine particle is excessively high, decomposition or deterioration of the electrolyte may occur due to an increase in side reactions. According to an embodiment, a weight ratio of the bulk particle to the fine particle may be 10:1 to 3:1.

The binder may mediate bonding between the substrate ST and an active material, thereby improving mechanical stability. For example, the binder may be an organic binder or an aqueous binder, and may be used with a thickener such as carboxylmethyl cellulose (CMC). For example, the organic binder may be any one of vinylidene fluoride-hexafluoropropylene copolymer (PVDF-co-HFP), polyvinylidene fluoride (PVDF), polyacrylonitrile, and polymethylmethacrylate, and the aqueous binder may be styrene-butadiene rubber (SBR).

The conductive material may improve electrical conductivity of the rechargeable battery. The conductive material may include a metal material. For example, the conductive material may include a carbon material, e.g., graphite, carbon black, graphene, and/or carbon nanotubes.

The slurry used in the manufacture of the above-described active material layer AM may include the above-described graphite particle A1, a binder, and a conductive material, as well as a solvent. The solvent may be an organic solvent such as N-methylpyrrolidone, dimethyl formamide, acetone, dimethyl acetamide, water, or a combination thereof. For example, a slurry including such a solvent may include 5 wt % to 30 wt % of graphite particles, 1 wt % to 10 wt % of binder, 1 wt % to 10 wt % of conductive material, and 50 wt % to 90 wt % of solvent, based on 100 wt % of the slurry.

In the electrode plate manufacturing method according to an embodiment of the present disclosure, during a drying process of the slurry, the solvent included in the slurry may be removed while being gasified during the drying process. In this case, the graphite particles A1 may be maintained in a state of being oriented in a specific direction. A detailed description of the electrode plate manufacturing method according to an embodiment will be provided later.

When the electrode plate 30 is the positive electrode plate 30A (FIG. 1), the active material layer may include a positive electrode active material. The positive electrode active material may be a material into which lithium (Li) ions can be inserted and delithiated.

The positive electrode active material may be a lithium metal oxide. For example, the positive electrode active material may be one of a lithium manganese oxide, a lithium nickel oxide, a lithium cobalt oxide, a lithium nickel manganese oxide, a lithium nickel cobalt manganese oxide, a lithium nickel cobalt aluminum oxide, a lithium phosphoric acid iron compound, a lithium phosphoric acid manganese compound, a lithium phosphoric acid cobalt compound, and a lithium phosphoric acid vanadium compound.

When the electrode plate 30 the negative electrode plate 30B (FIG. 1), the active material layer may include a negative electrode active material. The negative electrode active material may be a material into which lithium ions can be inserted and delithiated. For example, the negative electrode active material may be any one of a carbon material such as crystalline carbon, amorphous carbon, carbon composites, or carbon fibers, a lithium alloy, silicon (Si), or tin (Sn). According to another embodiment, the negative electrode active material may be natural graphite or artificial graphite.

The electrode plate manufacturing method according to an embodiment of the present disclosure to be described later may include a process of forming a groove in a slurry during a process of drying the slurry, and a slurry mixing process, a coating process, and a magnetization process may be performed before the processes.

The mixing process may be performed by mixing graphite particles, binder, conductive agent, and solvent to create the slurry. Air bubbles contained in the slurry may be completely defoamed during the slurry mixing process.

When the electrode plate is a negative plate, a negative electrode solid concentration of the slurry mixed in the mixing process may be within a range of 50 wt % to 60 wt %, based on 100 wt % of the slurry. In addition, when the electrode plate is a positive electrode plate, a positive electrode solid concentration of the slurry mixed in the mixing process may be within a range of 70 wt % to 80 wt %, based on 100 wt % of the slurry.

The coating process may coat the slurry onto a substrate. The coating process may coat the slurry on the substrate using a coating device.

This coating device for this purpose may be, e.g., a dual slot die coater. The dual slot die coater may precisely apply the slurry at a consistent thickness and area. The dual slot die coater may receive slurry from a slurry storage unit, inject the slurry into a nozzle, and evenly spread and apply the slurry onto a substrate through each of a plurality of slots. A detailed description of the dual slot die coater will be omitted.

The aforementioned material may be transported by a transport device. A transport device for this purpose may be, e.g., a device that transports a material in a roll-to-roll manner. A metal foil that may be used as a substrate for an electrode plate of a rechargeable battery may be transported in a direction by coming into contact with a plurality of rollers.

The magnetization process may magnetize the slurry coated on the substrate. The magnetization process may be carried out by a magnetizing device. The magnetizing device may magnetize the slurry discharged by the dual slot die coater. The magnetizing device may apply a magnetic field to the slurry applied on the substrate to orient it.

The magnetization process described above may be a process of magnetically aligning the graphite contained in a negative electrode to improve charging performance of the negative electrode. More specifically, during the manufacture of the negative electrode, a specific crystal plane of graphite may be oriented so as to be nearly horizontal to a negative electrode current collector in a magnetic field, and an oriented state may be fixed in a drying process to be described later.

As an edge surface of a graphite layer faces the positive electrode active layer due to an orientation of the graphite, the insertion and delithiation of lithium ions may be smoothly performed, and a conduction path of electrons may be shortened, so electron conductivity of the negative electrode may be improved, thereby improving charge and discharge performance of the rechargeable battery.

Hereinafter, a method for manufacturing an electrode plate according to an embodiment of the present disclosure that may be performed after the aforementioned processes will be described in detail with reference to the drawings.

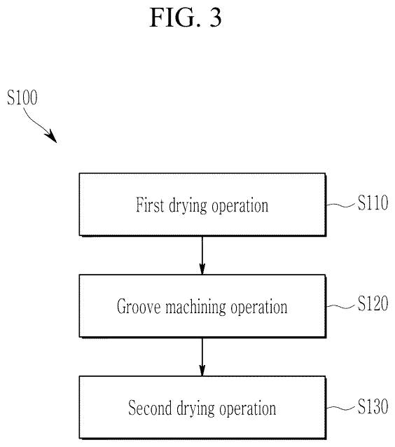

FIG. 3 illustrates a flowchart showing a manufacturing method for an electrode plate according to an embodiment of the present disclosure.

Referring to FIG. 3, an electrode plate manufacturing method (S100) according to an embodiment of the present disclosure may include a first drying operation (S110), a groove machining operation (S120), and a second drying operation (S130). The first drying operation (S110) may be performed after discharging and magnetizing the slurry, discussed previously.

The first drying operation (S110) may dry the slurry coated on the substrate. The first drying operation (S110) may dry the slurry by 70% or more.

The groove machining operation (S120) may create a groove in the slurry during the drying process of the slurry. That is, in the groove machining operation (S120), the groove may be created in the slurry before the drying of the slurry is completed. For example, the groove machining operation (S120) may be performed when the slurry is 70% to 80% dried.

When the groove machining operation (S120) is performed in a state where the slurry is dried to less than 70%, it may be difficult to maintain a shape of the groove. In contrast, when the groove machining operation (S120) is performed in a state where the slurry is dried to more than 80%, the slurry may be dried excessively, making it difficult to process the groove into a target shape. Additionally, in the rolling process that can be performed after the groove is machined, delamination or deformation may occur inside the groove.

The method for checking a degree of drying of the slurry in the groove machining operation (S120) and the second drying operation (S130) may be done by drying the slurry at regular intervals and then measuring the solvent remaining in the slurry. That is, a degree of processing of the slurry may be determined by using a method of sampling the slurry while it is being dried.

The second drying operation (S130) may continuously dry the slurry until the drying of the slurry in which the groove is created is completed, to create an active material layer. The second drying operation (S130) and the first drying operation (S110) may be performed sequentially.

That is, in the electrode plate manufacturing method (S100) according to an embodiment of the present disclosure, the first drying operation (S110) and the second drying operation (S130) may not be performed independently, but rather the first drying operation (S110) and the second drying operation (S130) may be performed continuously without interruption (e.g., there may not be a pause in drying between the first drying operation (S110) and the second drying operation (S130)), and the groove machining operation (S120) may be performed at a specific time point. For example, the groove machining operation (S120) may be performed at a specific time point during the continuously and sequentially performed first and second drying operations (S110) and (S130) (e.g., so the groove machining operation (S120) may set or define a time point between the continuous first and second drying operations (S110) and (S130)).

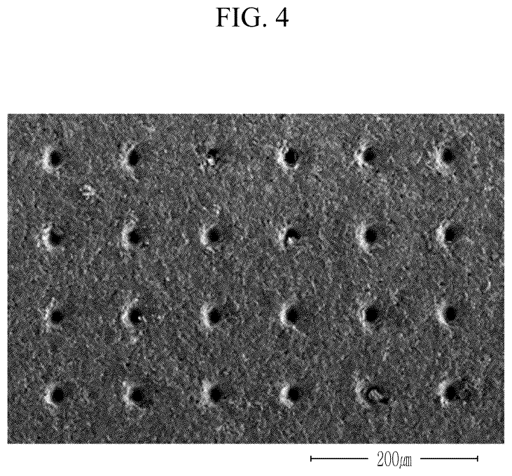

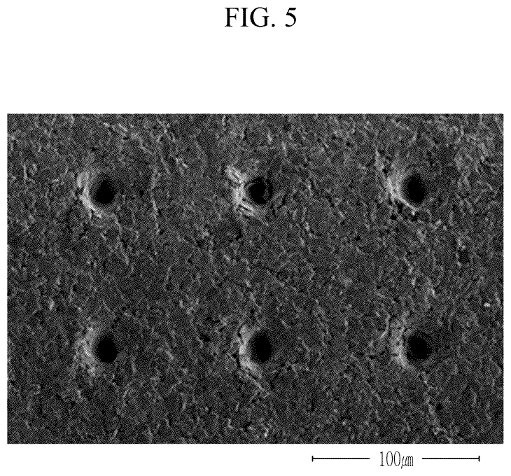

FIG. 4 illustrates an image of an active material layer with a groove, as formed by the electrode plate manufacturing method (S100) at a magnification of 500 times. FIG. 5 illustrates an enlarged image of FIG. 5 (i.e., at a magnification of 1000 times).

Referring to FIGS. 4 and 5, an electrode plate manufactured by the electrode plate manufacturing method (S100) according to an embodiment of the present disclosure as described above did not cause detachment from the groove even when a process of rolling with a roller was performed after the second drying operation (S130).

In detail, the electrode plate manufacturing method (S100) according to the present disclosure may perform the process of forming the groove in the slurry during the slurry drying process (rather than after the slurry drying is completed). Accordingly, in this case, there is no need to pressurize the electrode plate that has already been pressed for groove machining. Accordingly, excessive pressure may not be applied to the groove, thereby preventing local over-compression of the active material and detachment of the active material inside the groove.

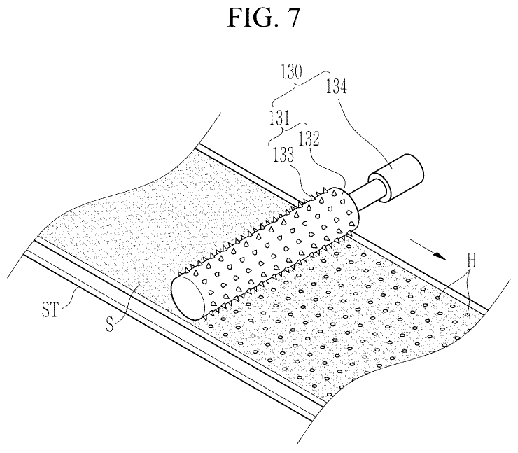

Hereinafter, an electrode plate manufacturing apparatus according to an embodiment of the present disclosure for carrying out the electrode plate manufacturing method (S100) as described above will be described with reference to FIGS. 6 and 7.

FIG. 6 illustrates a schematic cross-sectional view of an electrode plate manufacturing apparatus according to an embodiment of the present disclosure, and FIG. 7 illustrates a perspective view showing an extract of a groove machining unit included in the electrode plate manufacturing device of FIG. 6.

Referring to FIGS. 6 and 7, the electrode plate manufacturing apparatus 100 according to an embodiment of the present disclosure may include a heating unit 110 (e.g., a heater) and a groove machining unit 130 (e.g., a groove machine). For example, referring to FIG. 6, the groove machining unit 130 may be arranged between parts of the heating unit 110, and may be positioned over a movement path of the substrate ST.

In detail, the heating unit 110 may dry the slurry S coated on the substrate ST. The heating unit 110 for this purpose may include, e.g., a hot air injection member 111 and a heating member 112.

The hot air injection member 111 (e.g., a hot air injector) may be installed above the movement path of the substrate ST, and may be vertically (e.g., perpendicularly with respect to the movement path of the substrate ST) spaced apart from the substrate ST. The hot air injection member 111 may inject hot air toward the slurry S on the substrate ST. The hot air injection member 111 may be positioned upward with respect to the substrate ST based on a direction shown in the drawing.

The heating member 112 may be positioned on an opposite side to the hot air injection member 111 with respect to the substrate ST, and may generate heat to heat the substrate ST. The heating member 112 may be installed vertically spaced apart from the substrate ST.

The heating member 112 may be positioned on the opposite side of the hot air injection member 111. The heating member 112 may convert electrical energy into thermal energy to dry the slurry S.

The groove machining unit 130 may be installed inside the heating unit 110. In detail, the groove machining unit 130 may be positioned between the hot air injection member 111 and the heating member 112.

This groove machining unit 130 may create a groove H in the slurry S (FIG. 7) while drying of the slurry S is not complete. The groove machining unit 130 for this purpose may include, e.g., a groove machining member 131 and a driving member 134.

The groove machining member 131 may include a body portion 132 and a plurality of protrusions 133 positioned on a circumferential surface of the body portion 132. The body portion 132 may have a cylindrical shape. A length of the body portion 132 may be similar to a width of the substrate ST, or may be shorter than the width of the substrate ST.

The protrusion 133 may have a conical shape. The protrusion 133 may be positioned at regular intervals outside of the body portion 132. A length and diameter of the protrusion 133 may be changed depending on a design of the groove machining unit 130 and a thickness of the slurry S.

The driving member 134 may be coupled to the groove machining member 131 and may rotate the groove machining member 131. The driving member 134 may be a rotary motor. The rotary motor may rotate the groove machining member 131 in conjunction with a transport peed of the substrate ST.

As described above, the electrode plate manufacturing apparatus 100 according to an embodiment of the present disclosure may create the groove H in the slurry S while the slurry S is not completely dried.

In a comparative electrode plate manufacturing method, it may be difficult to create a large inner diameter of a groove, if the groove is formed after completely drying the slurry. However, the electrode plate manufacturing apparatus 100 according to the present disclosure may machine an inner diameter of the groove H as large as possible by machining the groove H in the slurry S that is not completely dried.

Accordingly, the groove H with a relatively large inner diameter may be created in the slurry S, thereby improving an electrolyte moisture content (see FIG. 8) and reducing ionic resistance. Further, lithium diffusion may be further improved. In addition, the electrode plate manufacturing apparatus 100 according to the present disclosure may prevent a thickness of an electrode plate from increasing by preventing occurrence of swelling at a peripheral portion of the groove H, thereby allowing the electrode plate to be manufactured with desired target values.

By way of summation and review, an electrode plate manufacturing method may include a slurry discharging operation for discharging slurry as a substrate, a magnetization operation for magnetically orienting graphite, and a drying operation for drying the slurry. For example, the magnetization operation may be an operation of magnetically orienting the graphite contained in the negative electrode to improve a charging performance of the negative electrode. More specifically, it may have a configuration in which a [0,0,2] crystal plane of graphite is oriented and fixed so that it is almost horizontal to the negative electrode current collector in a magnetic field during formation of the negative electrode.

After the drying operation, a process of rolling the active material layer may be performed. In addition, a process of forming a groove in the active material layer, after the rolling process, may be performed in order to increase hygroscopicity of an electrolyte and an active material layer.

In this case, additional pressure may be applied to a surface of the electrode plate by a groove machining device pressuring the electrode plate that has already been pressed. Accordingly, when excessive pressure is applied to the groove, local over-compression of the active material and detachment of the active material occur inside the groove.

Over-compression of the active material may reduce electrolyte moisture content, increase ionic resistance, and impede improvement of lithium diffusion. In addition, a thickness of the electrode plate may increase due to occurrence of swelling around the groove.

In contrast, the present disclosure provides a method and an apparatus for manufacturing an electrode plate capable of improving manufacturing quality. That is, the electrode plate manufacturing method according to the present disclosure may perform the process of forming the groove in the slurry during the slurry drying process rather than after the slurry drying is completed. Accordingly, in this case, there is no need to pressurize the electrode plate that has already been pressed for groove machining. Accordingly, excessive pressure may not be applied to the groove, thereby preventing local over-compression of the active material and detachment of the active material inside the groove.

In addition, the electrode plate manufacturing method according to the present disclosure may machine an inner diameter of the groove as large as possible by machining the groove in the slurry groove not completely dried (e.g., as opposed to machining a groove in a completely dried slurry). Accordingly, the groove with a relatively larger inner diameter may not only improve an electrolyte moisture content, but may also reduce ionic resistance. Additionally, lithium diffusion may be further improved.

In addition, the electrode plate manufacturing method according to the present disclosure may prevent a thickness of an electrode plate from increasing by preventing occurrence of swelling at a peripheral portion of the groove. Accordingly, the electrode plate may be manufactured to meet target values.

However, the technical features of the present disclosure are not limited to those mentioned above, and other technical features not mentioned may be clearly understood by those skilled in the art from the description above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A manufacturing method for an electrode plate, the method comprising:
performing a first drying of a slurry coated on a substrate;
machining a groove in the slurry while the slurry is being dried; and
performing a second drying of the slurry, such that the slurry is continuously dried during the first drying and the second drying until the slurry with the groove is dry to create an active material layer on the substrate.

2. The manufacturing method as claimed in claim 1, wherein the first drying dries the slurry by 70% or more.

3. The manufacturing method as claimed in claim 1, wherein machining the groove is carried out when the slurry is dried to 70% to 80%.

4. The manufacturing method as claimed in claim 1, wherein the first drying the second drying are performed sequentially.

5. The manufacturing method as claimed in claim 1, wherein a negative electrode solid concentration of the slurry is in a range of 50 wt % to 60 wt %, based on 100 wt % of the slurry.

6. The manufacturing method as claimed in claim 1, wherein a positive electrode solid concentration of the slurry is in a range of 70 wt % to 80 wt %, based on 100 wt % of the slurry.

7. The manufacturing method as claimed in claim 1, wherein the active material layer includes a positive electrode active material.

8. The manufacturing method as claimed in claim 7, wherein the positive electrode active material is one of a lithium manganese oxide, a lithium nickel oxide, a lithium cobalt oxide, a lithium nickel manganese oxide, a lithium nickel cobalt manganese oxide, a lithium nickel cobalt aluminum oxide, a lithium phosphoric acid iron compound, a lithium phosphoric acid manganese compound, a lithium phosphoric acid cobalt compound, and a lithium phosphoric acid vanadium compound.

9. The manufacturing method as claimed in claim 1, wherein the active material layer includes a negative electrode active material.

10. The manufacturing method as claimed in claim 9, wherein the negative electrode active material is a material into which lithium ions are to be inserted and delithiated, the negative electrode active material being a carbon material, a lithium alloy, silicon, or tin.

11. An electrode plate manufacturing apparatus, comprising:
a heating unit configured to dry a slurry coated on a substrate; and
a groove machining unit installed inside the heating unit, the groove machining unit being configured to create a groove in the slurry while drying of the slurry is not complete.

12. The apparatus as claimed in claim 11, wherein the heating unit includes:
a hot air injection member installed spaced apart from the substrate and configured to spray hot air toward the slurry; and
a heating member positioned on an opposite side to the hot air injection member based on the substrate and configured to heat the substrate by generating heat.

13. The apparatus as claimed in claim 11, wherein the groove machining unit includes:
a groove machining member including a body portion and a plurality of protrusions positioned on a circumferential surface of the body portion; and
a driving member coupled with the groove machining member and configured to rotate the groove machining member.

14. The apparatus as claimed in claim 13, wherein each of the plurality of protrusions has a conical shape.
